(19) United States
(12) Patent Application Publication
(10) Pub. No.: US 2024/0040963 A1
(43) Pub. Date: Feb. 8, 2024

(54) ROTARY CUTTER WITH FOLDING WING GUIDE

(71) Applicant: Schulte Industries Ltd., Saskatoon (CA)

(72) Inventor: Todd Hofmann, Saskatoon (CA)

(21) Appl. No.: 17/880,091

(22) Filed: Aug. 3, 2022

(51) Int. Cl. A01D 34/82; A01D 34/66; A01D 69/03

(52) U.S. Cl. CPC A01D 34/82; A01D 34/66; A01D 69/03; A01D 2101/00

(57) ABSTRACT

A rotary cutter is provided that has a center section and at least one wing section pivotally connected to the center section. The rotary mower is transformable between a transport position, with the wing section pivoted upwards, and an operating position, with the wing section pivoted downwards. A lifting assembly is provided between the center section and the at least one wing section to pivot the wing section. The lifting assembly can have a lifting actuator, a lug provided on the lifting actuator, a pivot member, and a pivotal connection between the lifting actuator and the pivot member. A guide member can run adjacent to the lifting actuator and have a guide channel for receiving the lug when the wing section is pivoted upwards into the transport position.

The present invention relates to rotary cutter and more particularly a rotary cutter that can transform between an operating position and a transport position.

### BACKGROUND

Some rotary cutters have a center section and one or more wing sections pivotally connected to the center section with cutting blades provided beneath the sections to cut grass or other vegetation with the rotary cutter. The pivoting wing sections allow the rotary cutter to be transformed between an operating position, where the wing sections are down so that the rotary cutter can be used to mow grass or other vegetation, and a transport position, where the wing sections are folded up to make the rotary cutter narrower for transporting, such as transporting it along a public roadway.

When the wing sections are folded down in their operating position, it is desirable to allow these wing sections to “float” while in the operating position, by allowing the wing sections to pivot relative to the center section. This “floating” of the wing sections allows the rotary cutter to better handle mowing uneven surfaces, which is especially useful since rotary cutters are often used to mow hills and ditches.

However, configuring a rotary mower to float when in an operating position can complicate the transformation of the rotary mower between positions. It is desirable to have rotary mower that allows a wing section to float while in operation, but still reliably transform between the different positions.

### SUMMARY OF THE INVENTION

In an aspect, a rotary cutter is provided that has a center section, at least one wing section pivotally connected to the center section, the rotary mower transformable between a transport position, with the at least one wing section pivoted upwards, and an operating position, with the at least one wing section pivoted downwards, cutting blades provided beneath the center section and the at least one wing section, ground wheels operatively connected to the center section and the at least wing section, a hitch assembly provided at the front of the center section, a lifting assembly provided between the center section and the at least one wing section. The lifting assembly can have a lifting actuator having a first end and a second end, the lifting actuator operatively connected at the first end to the center section, a lug provided on the lifting actuator, a pivot member having a first end and a second end, the first end pivotally connected to the second end of the lifting actuator and forming a pivotal connection between the pivot member and the lifting actuator, the second end pivotally connected to the at least one wing section, and a guide member running adjacent to the lifting actuator and having a guide channel provided in the guide member, the guide channel having an opening and defining a channel path. The lug is positioned in the guide channel when the rotary mower is in the transport position and the lug follows the channel path defined by the guide channel as the at least one wing section begins to pivot downwards toward the operating position. The guide channel restricts the vertical motion of the lug, as the lug travels along the channel path.

### DESCRIPTION OF THE DRAWINGS

A preferred embodiment of the present invention is described below with reference to the accompanying drawings, in which:

FIG. 1 is an isometric view of a rotary cutter;

FIG. 2 is an isometric view of the rotary cutter of FIG. 1 in a transport position;

FIG. 3 is a front view of the rotary cutter of FIG. 1;

FIG. 4 is a close up view of a lifting assembly on the rotary cutter of FIG. 1 with the chain guard removed;

FIG. 5 is a front view of the rotary cutter of FIG. 1, with the chain guard removed, in a fully floated up position;

FIG. 6 is a front view of the rotary cutter of FIG. 1, with the chain guard removed, in a fully floated down position;

FIG. 7 is front view of the rotary cutter of FIG. 1, with the chain guard removed, with the lifting assemblies starting to lift wing sections;

FIG. 8 is front view of the rotary cutter of FIG. 1, with the chain guard removed, with the lifting assemblies lifting the wing sections to an approximately 45 degree angle;

FIG. 9 is front view of the rotary cutter of FIG. 1, with the chain guard removed, with the lifting assemblies lifting the wing sections and lugs just entering guide channels;

FIG. 10 is a close up view of the rotary cutter of FIG. 1, with the chain guard removed, with the lug just entering the guide channel; and

FIG. 11 is a close up view of the rotary cutter of FIG. 1, with the chain guard removed, with the lug reaching the end of the guide channel and the wing sections rotated upwards to the transport position.

### DETAILED DESCRIPTION OF THE ILLUSTRATED EMBODIMENTS

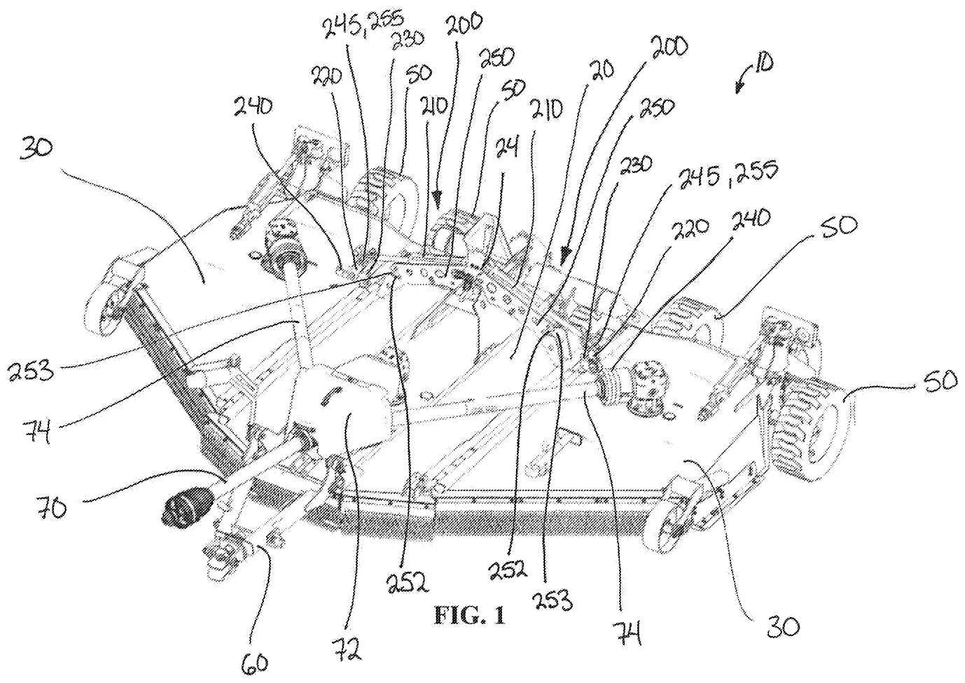

FIG. 1 illustrates a rotary cutter 10 that is towed by a tow vehicle (not shown), such as a tractor, for cutting grass and other vegetation. The rotary cutter 10 can have a center section 20 and two (2) wing sections 30 pivotally connected to the center section 20 so that the wing sections 30 can be rotated relative to the center section 20. Rotating cutting blade 40 can be provided beneath the center section 20 and the wing sections 30 to cut vegetation when the rotary cutter 10 is in operation.

Ground wheels 50 can be provided attached to the center section 20 and the wing sections so that the rotary cutter 10 can be pulled along a ground surface. In one aspect, these ground wheels 50 can be attached behind the center section 20 and the wing sections 30.

A hitch assembly 60 can be provided at the front of the rotary cutter 10 and can be provided at the front of the center section 20 so that the rotary cutter 10 can be connected to a tow vehicle (not shown) and towed by the tow vehicle.

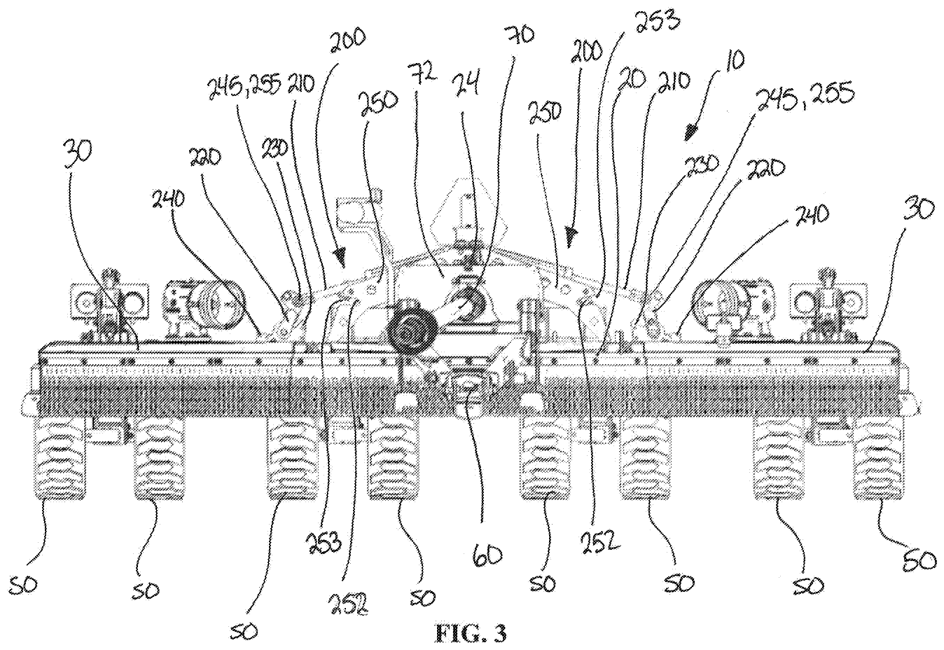

The rotary cutter 10 can be powered by a by a power take off (PTO) on the tow vehicle, which connects to a PTO shaft 70 on the rotary cutter 10, which in turn, is connected to a transfer case 72, that transfers rotational motion of the PTO shaft 70 to drive shafts 74 that transfer rotational motion to the cutting blades 40 beneath the center section 20 and the wing sections 30. (Drive shafts 74 have been removed and are not shown in FIGS. 3-11)

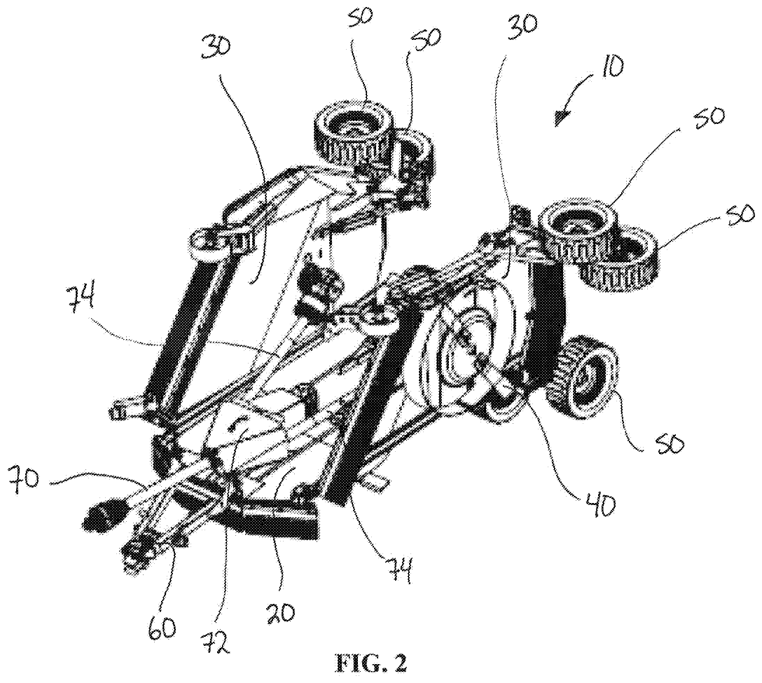

The rotary cutter 10 can be transformed between an operation position shown in FIG. 1, where the rotary cutter 10 can be used to cut vegetation, and a transport position shown in FIG. 2, where the wings sections 30 can be pivoted upwards, around sides of the wing sections connected to sides of the center section 20, to reduce the width of the rotary cutter 10 for transport.

Referring to FIG. 3, the rotary cutter 10 can pivot the wing sections 30 by means of lifting assemblies 200. A lifting assembly 200 can be provided for each wing section 30 and provided between the center section 20 and the wing section 30. The lifting assembly can have: a lifting actuator 210; a pivot member 220; an inner stop 230; an outer stop 240; and a guide member 250.

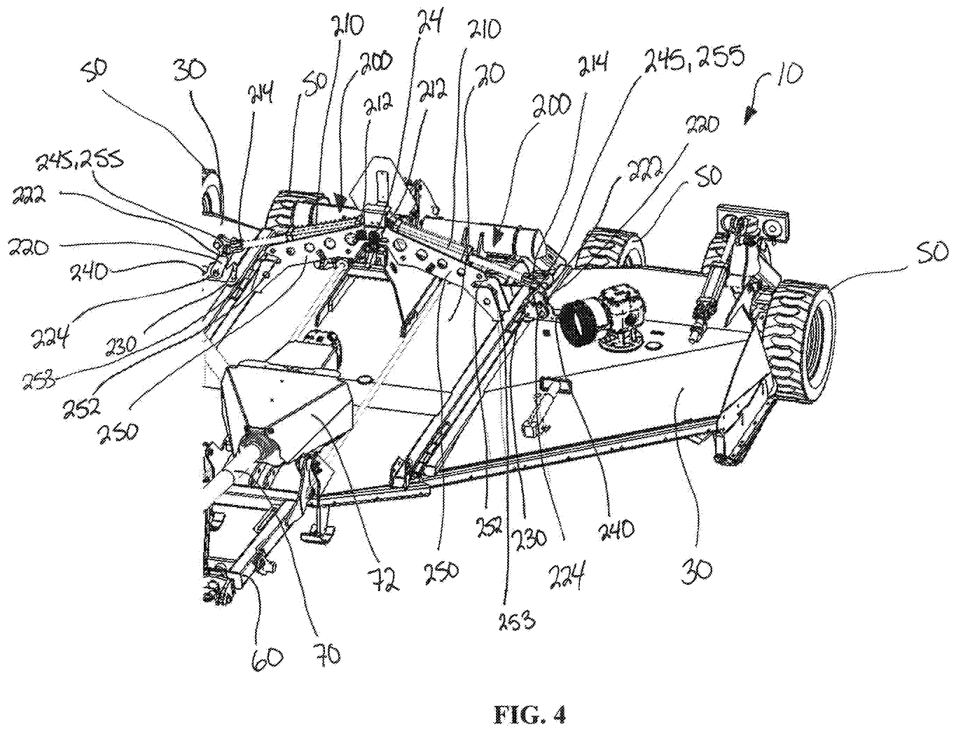

FIG. 4 illustrates a close up view of the lifting assemblies 200. The lifting actuator 210 can be a hydraulic cylinder and can be operatively connected at a first end 212 to the center section 20 (in the figures the first end 212 of the lifting actuator 210 is shown connected to a center tower 24 on the center section 20) such that the lifting actuator 210 can freely pivot around its first end 212. The second end 214 of the lifting actuator 210 can be pivotally connected to the to the pivot member 220.

The pivot member 220 can be pivotally attached at a first end 222 to the second end 214 of the lifting actuator 210 and a second end 224 of the pivot member 220 can be pivotally attached to the wing section 30. The connection of the second end 214 of the lifting actuator 210 and the first end 222 of the pivot member 220 forms a pivotal connection 245 between the lifting actuator 210 and the pivot member 220.

Lugs 255 can be provide at the second end 214 of the lifting actuator 210. In one aspect, the lugs 255 can be provided at the pivotal connection 245 between the lifting actuator 210 and the pivot member 220. However, the lugs 255 could also be offset from the pivotal connection 245 a set distance.

The inner stop 230 and the outer stop 240 can be provided to restrict the pivoting of the pivot member 220 around its second end 224.

The guide member 250 can be provided running adjacent to lifting actuator 210 with a guide channel 252 provided in the guide member 250. In one aspect, the guide member 250 may run along either side of the lifting actuator 210. In another aspect, the guide member 250 can run along both sides of the lifting actuator 210 so that the lifting actuator 210 is inside the guide member 250 as shown in FIG. 4.

The guide channel 252 is positioned in the guide member 250 and can have an opening 253 so that the lug 255 enters the guide channel 252 through the opening 253 when the lifting actuator 210 is retracted near the end of its retraction. With continued retraction of the lifting actuator 210, the lug 255 travels along the guide channel 252 through a channel path defined by the guide channel 252, until the lug 255 reaches an end of the guide channel 252. In one aspect, the lug 255 can reach the end of the guide channel 252 substantially simultaneously with the lifting actuator 210 reaching its fully retracted position.

As the lug 255 follows the channel path defined by the guide channel 252, the pivotal connection 245 between the lifting apparatus 210 and the pivot member 220 follows a connection path defined by the channel path the lug 255 follows. In one aspect, if the lug 255 is provided at the pivotal connection 245, the channel path and the connection path will be the same path. However, if the lug 255 and the pivotal connection 245 are offset from for each other, the channel path and the connection may be different, but related paths.

The wing sections 30 of the rotary cutter 10 must be able to “float” relative to the center section 20 in order to adjust the mowing uneven surfaces. This is achieved in the rotary cutter 10 by allowing the wing sections 30 to freely pivot, at least within a limited range, relative to the center section 20, when the rotary cutter 10 is in the operating position.

Rotary cutters 10 are commonly used to mow hills and ditches, so this floating of the wing sections 30 allows the rotary cutter 10 to mow such uneven terrain and other uneven terrain. For example, when the rotary cutter 10 is use to mow a ditch, one or more of the wing sections 30 may angle upwards, relative to the center section 20, if the rotary cutter is being pulled along or near the bottom of the ditch. Conversely, if the rotary cutter is being pulled along the top of the ditch, one or more of the wing sections 30 may angle downwards, relative to the center section 20, to accommodate the downward slope of the ditch.

FIG. 3 illustrates the rotary mower 10 in the operating position where the lifting assemblies 210 are allowing the wing sections 30 to float by allowing the wing sections to pivot relative to the center section 20. The lifting actuators 210 are held in an extended position and the pivot members 220 connected between the lifting actuator 210 and the wing sections 30 still allows the wing sections 30 to pivot relative to the center section 20. The pivot members 220 can freely pivot in between the inner stop 230 and the outer stop 240, allowing the pivot member 220 to pivot relative to the wing sections 20, but restricted by the inner stop 230 and the outer stop 240.

Referring to FIG. 4, while the length of the lifting actuator 210 is set in the operating position, the lifting member 210 can freely pivot around its first end 212 connected to the center section 20 and its second end 214 forming the pivotal connection 245 with the pivot member 220. This allows the position of the pivotal connection 245 to move along arcs defined by the length of the lifting actuator 210 and the pivot member 220, which in turn, allows the pivot member 220 to pivot relative to the wing section 30. This allows for the “floating” of the wing sections 30, when the rotary cutter 10 is placed in the operation position.

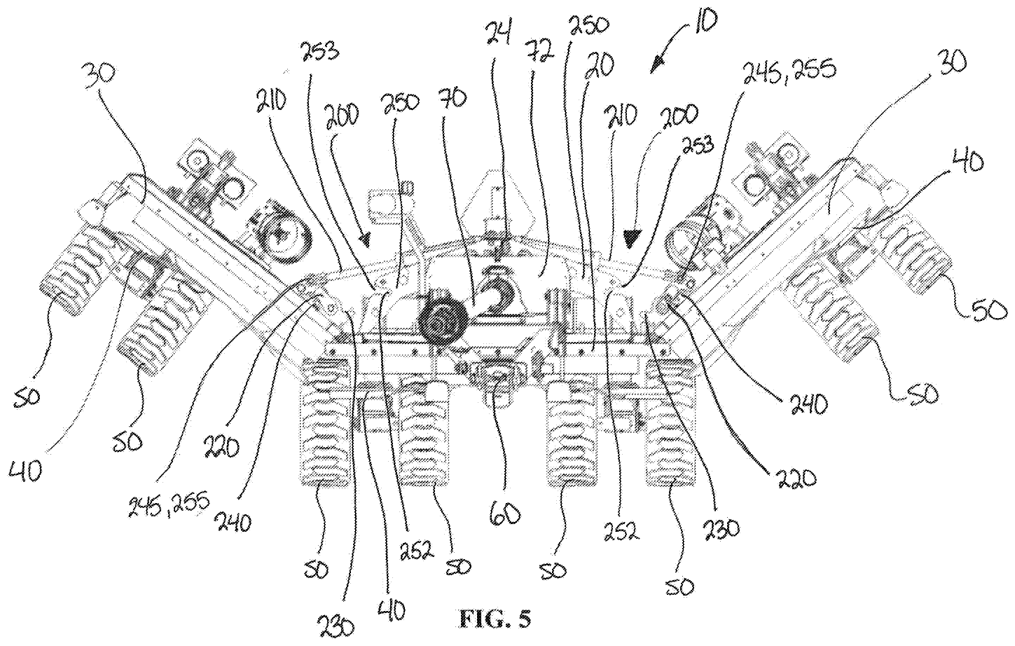

When one or both of the wing sections 30 pass over higher ground than the center section 20, the freely pivoting pivot member 220 allows the wing sections 30 to pivot upwards. This upwards pivoting of the wing sections 30 can continue until the pivot members 220 have pivoted far enough to come into contact with the outer stops 240, where the outer stops 240 will stop the wing sections 30 from pivoting upwards any further. FIG. 5 illustrates the wing sections 30 having floated or pivoted upwards their maximum amount, when the rotary cutter 10 is in the operating position, with the pivot members 220 in contact with the outer stop 240, preventing any further pivoting upwards of the wing sections 30.

Conversely, when the center section 20 passes over higher ground than one or both of the wing sections 30, the freely pivoting pivot member 220 allows the wing sections 30 to pivot downwards. This downward pivoting of the wing sections 30 can continue until the pivot members 220 have pivoted far enough to come into contact with the inner stop 230. The inner stops 230 will stop the wing sections 30 from pivoting downwards any further.

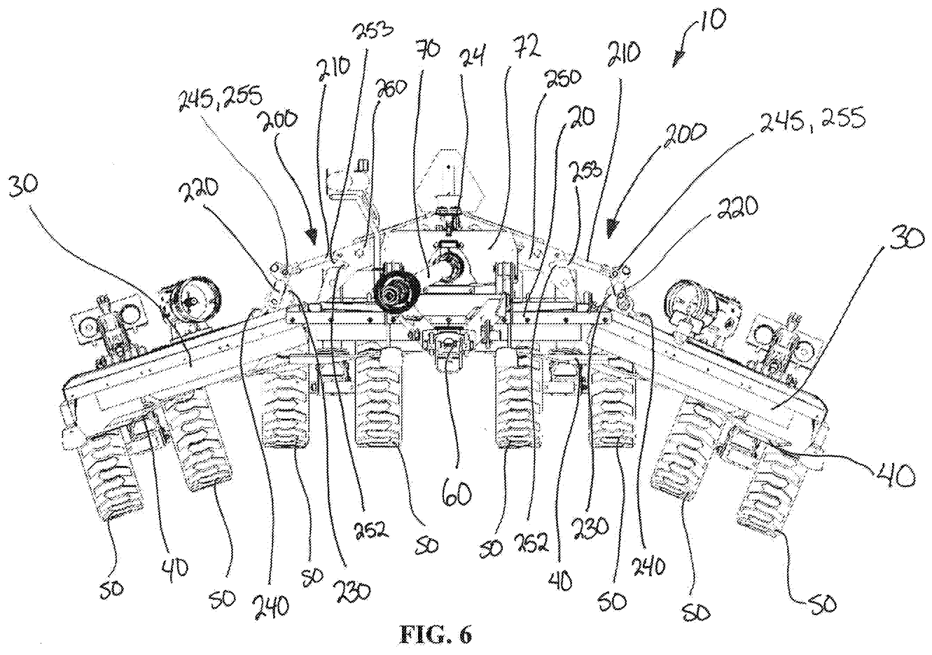

FIG. 6 illustrates the wing sections 30 having floated downwards their maximum amount with the pivot members 220 in contact with the inner stops 230, preventing any further motion downwards of the wing sections 30.

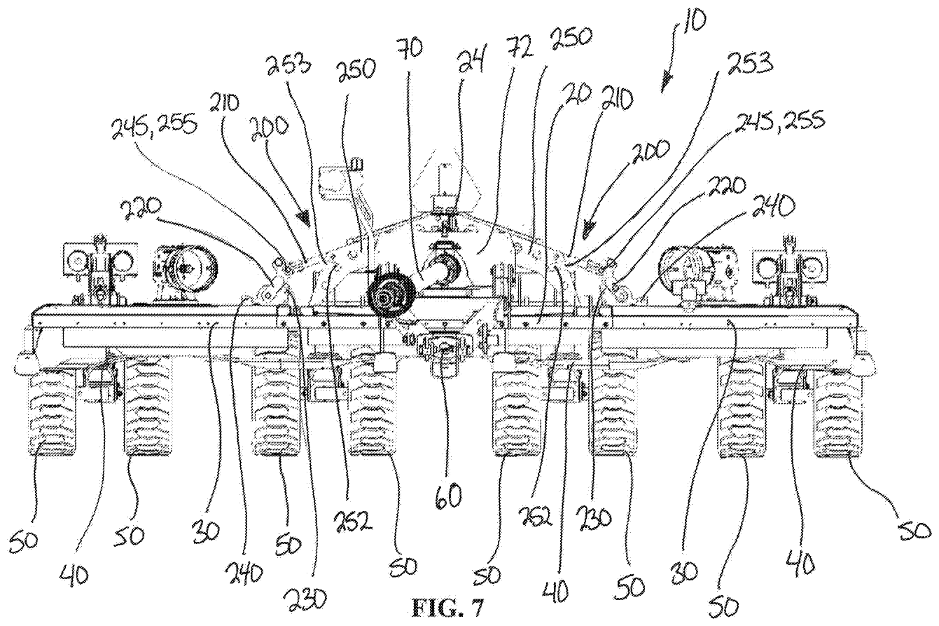

To transform the rotary cutter 10 from the operating position shown in FIG. 1 to the transport position shown in FIG. 2, the lifting assemblies 200 can be used to pivot the wing sections 30 upwards until they are vertical or near vertical. FIG. 7 illustrates the lifting assemblies 200 just starting to lift the wing sections 30 of the rotary cutter 10 to place the rotary cutter 10 in the transport position. The lifting actuators 210 have started to retract, pivoting the pivot members 220 up against the inner stops 230. With the pivot member 220 held in place by the inner stops 230, further retraction of the lifting actuator 210 will start to pivot the wing sections 30 upwards.

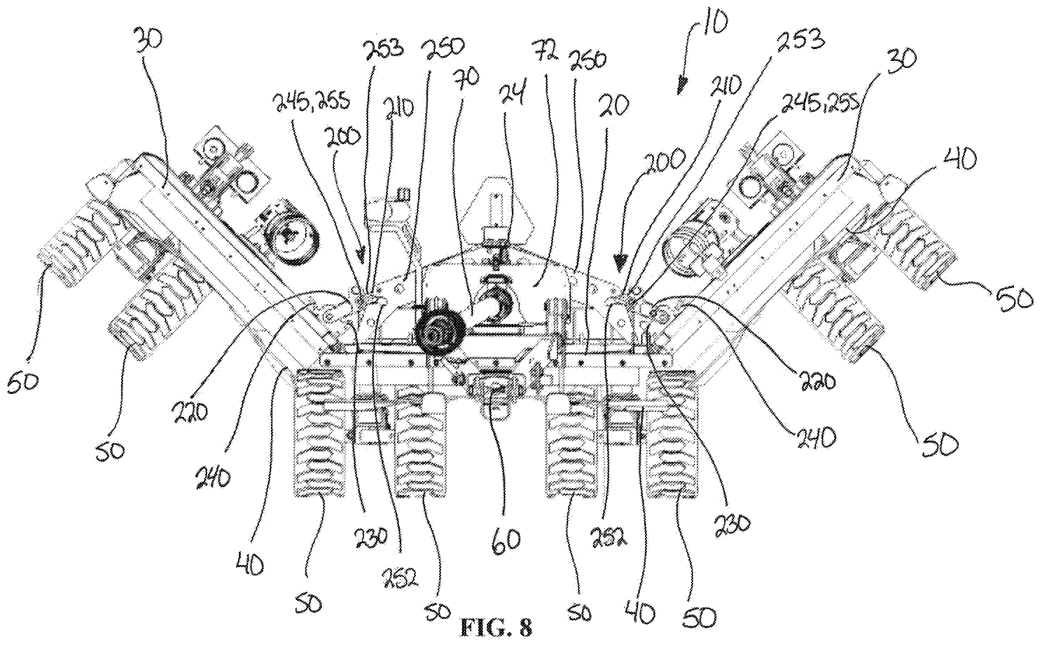

FIG. 8 illustrates the lifting assemblies 200 pivoting the wing sections 30 to approximately a 450 angle to the center section 20. The lifting actuators 210 are substantially aligned with the pivot members 220 causing further retraction of the lifting actuators 210 to act directly on the wing sections 30 further pivoting the wing sections 30 upwards.

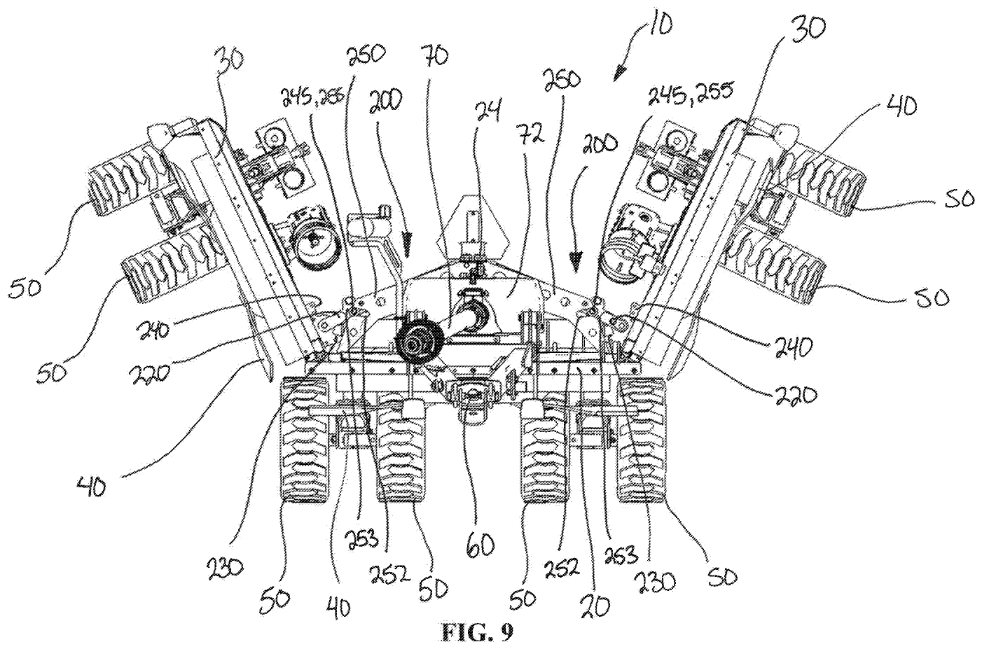

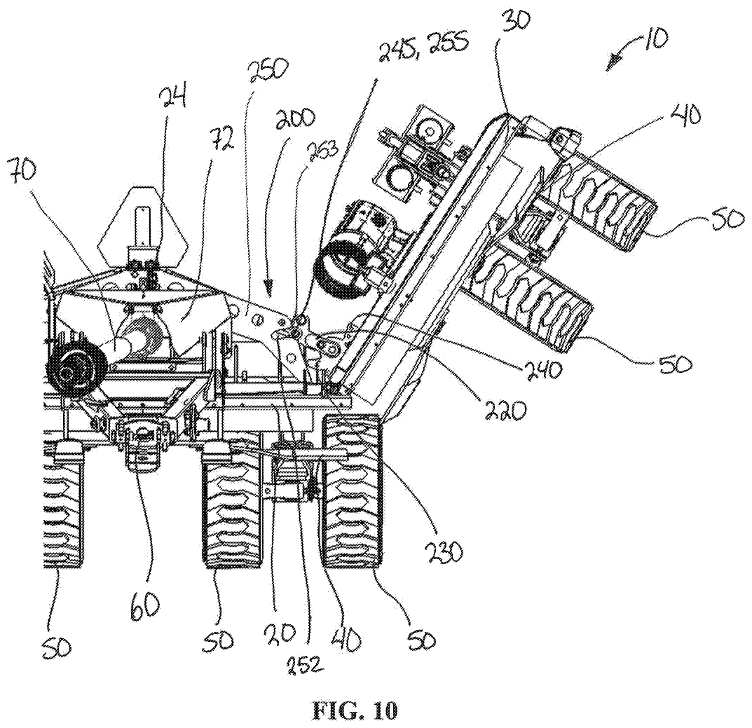

FIG. 9 illustrates the lifting assemblies 200 lifting the wing sections 30 high enough so that the lugs 225 are just starting to enter the opening 253 of the guide channel 252. Referring to FIG. 10, a closer view of the lug 225 entering the opening 253 of the guide channel 252 is shown. With the lug 252 entering the guide channel 252, the lug 252 is forced to following the channel path defined by the guide channel 252 as the lifting actuator 210 retracts.

The channel path defined by the guide channel 252 restricts the vertical movement of the lug 225 because it is forced to follow along the channel path and therefore the vertical movement of the pivotal connection 245 as it is forced travels along the connection path, restricting the vertical movement of the pivotal connection 245.

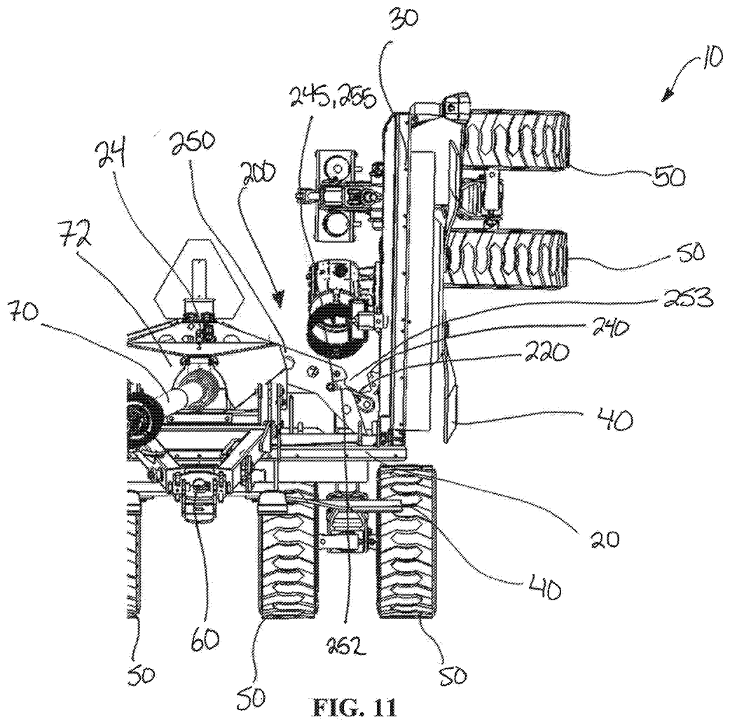

FIG. 11 illustrates the wing section 30 fully pivoted upwards into the transport position, with the lug 252 having travelled the length of the guide channel 252 to its end.

While incorporating the freely pivoting pivot member 220 between the lifting actuator 210 and the wing section 30 and the pivotal connection 245 between the pivot member 220 and the lifting actuator 210 allows the wing section 30 to float when the rotary cutter is in the operating position, which is desirable, it can complicate the lowering of the wing section 30 from the transport position to the operating position, especially when the rotatory cutter 10 is on an angled surface. Ideally, when the rotary cutter 10 is in the transport position with the wing sections 30 pivoted in their upright positions, the wing sections 30 are not quite vertical so that the weight of the wing sections 30 wants to pivot the wing sections 30 downwards. This downward force will be counteracted by the retracted lifting actuators 210 and as the rotary cutter 10 is being transformed between the transport position and the operating position, the lifting actuators 210 and the pivot member 220 are in tension, slowing down and controlling the downward pivoting of the wing sections 30 until the rotary cutter 10 is in the operating position. The pivoting downwards of the wing section 30 during this transformation will be relative to the extending of the lifting actuator 210.

However, if the rotary cutter 10 is on an angle so that the weight of one of the wing sections 30 is acting against the wing section 30 pivoting downwards to the operating position or there is debris in the connection between one of or both of the wing sections and the center section 20 requiring some force to be exerted on the wing section 30 for it to pivot downwards, without the guide member 250 and the guide channel 252, the pivotal connection 245 between the lifting actuator 210 and the pivot member 220 would complicate this process. Without the guide member 250 and the guide channel 252, the pivotal connection 245 between the lifting actuator 210 and the pivot member 220 is free to move vertically as well has horizontally, allowing the pivot member 220 to pivot relative to the wing section 30. This initial pivoting of the pivot member 220, instead of placing force on the wing section 30 to force it downwards towards the operating position, can just cause the pivot member 220 to pivot as the lifting actuator 210 extends and the pivotal connection 245 moves upwards. As the pivot member 220 continues to pivot, it will not place any significant force against the wing section until the pivot member 220 pivots up against the outer stop 240. Once the pivot member 220 pivots up against the outer stop 240, the pivot member 220 and therefore the lifting actuator 210 will start placing a force on the wing section 30 to move it towards the operating position.

With the pivot member 220 pivoted up against the outer stop 240, the lifting actuator 210 and the pivot member 220 can continue to push on the wing section 30, through the outer stop 240, until the wing section 30 has pivoted far enough that the weight of the wing section 30 will cause the wing section 30 to pivot downwards under its own weight. At this point, the lifting actuator 210 will not be placing a force on the wing section 30 and instead, forces on the lifting actuator 210 will have to switch to placing the lifting actuator 210 in tension, holding up the wing section 30 and preventing the wing section from pivoting more than the extension of the lifting actuator 210 will allow. This will require the lifting actuator 210 and the pivot member 220 to be aligned or substantially aligned.

When the wing section 30 starts pivoting downwards under its own weight, the pivot member 220 will initially be pushed up against the outer stop 240. Before the lifting actuator 210 and the pivot member 220 become aligned, the pivot member 220 will have to pivot back the other way until it becomes aligned with the lifting actuator 210. While the pivot member 220 is pivoting backwards to an aligned position with the lifting actuator 210, the wing section 30 is free to pivot downwards which can cause the wing section 30 to drop. This dropping of the wing section 30 will occur until the lifting actuator 210 and the pivot member 220 becomes aligned, at which time, the lifting actuator 210 and the pivot member 220 will “catch” or stop the dropping wing section 30 by rapidly being placed in tension.

The wing section 30 with all of its components is very heavy and the uncontrolled drop of the wing section 30 can be unpredictable and dangerous. Additionally, when the lifting actuator 210 and the pivot member 220 suddenly are placed in tension by becoming aligned and “catching” the dropping wing section 30, this can create a significant impact force on the lifting assembly 200, as well as other components of the rotary cutter 10, which can shorten the operating life of or even damage the lifting actuator 210, especially if it is a hydraulic cylinder, and other components of the rotary cutter 10.

The use of the guide member 250 and its guide channel 252 can reduce or prevent this dropping of the wing section 30 and can significantly lessen the impact force it places on the lifting assembly 200 and the rotary cutter 10 when the lifting actuator 210 switches from placing a force against the wing section 30 to being placed in tension when the wing section 30 starts pivoting downwards under its own weight. When the wing section 30 is in the transport position, folded upwards, the lug 255 can be positioned at the end of the guide channel 252, as shown in FIG. 11. When the lifting actuator 210 starts extending to pivot the wing section 30 down into the transport position, if the wing section 30 will not pivot downwards under its own weight, then the lifting actuator 210 will have to place a force on the wing section 30, pushing against the wing section 30. Rather than the pivot member 220 pivoting relative to the wing section 30 as the lifting actuator 210 starts to extend in this situation, the guide channel 252 restricts the vertical movement of the lug 255, and specifically its upward movement, which forces the lug 255 to follow the channel path defined by the guide channel 252 as the lifting actuator 210 extends. This restriction in the vertical movement of the lug 255 will also restrict the vertical movement, and particularly the upward movement, of the pivotal connection 245 between the lifting actuator 210 and the pivot member 220. Because vertical movement of the pivotal connection 245 is restricted, the pivot member 220 is prevented from pivoting freely relative to the wing section 30, and instead, places a force on the wing section 30 pushing the wing section 30 to pivot it downwards.

As the lifting actuators 210 continues to extend, the lug 225 will continue to move along the channel path defined by the guide channel 252. The vertical movement of the lug 225 and therefore the vertical movement of the pivotal connection 245 will continue to be restricted by the guide channel 252 because the lug 225 will be forced to follow channel path as the lug 225 moves along the guide channel 252. When the wing section 30 begins to pivot downwards under its own weight, the lifting actuator 210 and the pivot member 220 will have to be placed in tension to control how fast the wing section 30 pivots downward and limit or even stop the wing section 30 from dropping. However, because the vertical movement of the lug 255 and the pivotal connection 245 has been restricted by the guide channel 252, the lifting actuator 210 and the pivot member 220 should be closer to being aligned, if not already aligned or substantially aligned, lessening or even preventing any drop in the wing section 30 and reducing, if not preventing, any impact load.

The channel path defined by the guide channel 252 is primarily horizontal, but can also vary somewhat vertically along the length of the channel path. The guide channel 252 may not prevent vertical movement of the lug 225 and pivotal connection 245, but merely restrict it to the channel path and the connection path. In one aspect, the channel path defined by the guide channel 252 can vary vertically along its length to keep the lifting actuator 210 and the pivot member 220 substantially aligned the entire time the lug 225 is passing along the guide channel 252.

The length of the guide channel 252 can be chosen to restrict the vertical movement of the pivotal connection 245 long enough to ensure that the wing section 30 is pivoting downward under its own weight. Eventually, the wing section 30 has pivoted downward far enough that there is little or no risk that the wing section 30 is not pivoting downwards under it own weight and the lug 255 can exit the guide channel 252 in the guide member 250 through the opening 253 while the wing section 30 is still pivoting downwards to the operating position and before the wing section 30 has pivoted downwards all of the way to the operating position. FIGS. 9 and 10 show the wing section 30 in a position where the lugs 255 are at the opening 253 of the guide channel 252.

In one aspect, the length of the guide channel 252 can be selected so that the lug 252 is positioned at the opening 253 of the guide channel 252, either entering or exiting the guide channel 252, depending on whether the wing section 30 is being pivoted upward into the transport position or downwards into the operating position, when the wing section 30 is rotated upwards approximately 65° relative to the center section 20.

The foregoing is considered as illustrative only of the principles of the invention. Further, since numerous changes and modifications will readily occur to those skilled in the art, it is not desired to limit the invention to the exact construction and operation shown and described, and accordingly, all such suitable changes or modifications in structure or operation which may be resorted to are intended to fall within the scope of the claimed invention.

1. A rotary cutter comprising:
a center section;
at least one wing section pivotally connected to the center section, the rotary mower transformable between a transport position, with the at least one wing section pivoted upwards, and an operating position, with the at least one wing section pivoted downwards;
cutting blades provided beneath the center section and the at least one wing section;
ground wheels operatively connected to the center section and the at least wing section;
a hitch assembly provided at the front of the center section;
a lifting assembly provided between the center section and the at least one wing section, the lifting assembly comprising:
a lifting actuator having a first end and a second end, the lifting actuator operatively connected at the first end to the center section;
a lug provided on the lifting actuator;
a pivot member having a first end and a second end, the first end pivotally connected to the second end of the lifting actuator and forming a pivotal connection between the pivot member and the lifting actuator, the second end pivotally connected to the at least one wing section; and
a guide member running adjacent to the lifting actuator and having a guide channel provided in the guide member, the guide channel having an opening and defining a channel path,
wherein the lug is positioned in the guide channel when the rotary mower is in the transport position and the lug follows the channel path defined by the guide channel as the lifting actuator extends,
and wherein the guide channel restricts the vertical motion of the lug, as the lug travels along the channel path.

2. The rotary cutter of claim 1 wherein the guide channel restricts upwards movement of the lug as it passes through the guide channel.

3. The rotary cutter of claim 1 wherein the lug is provided at the second end of the lifting actuator.

4. The rotary cutter of claim 3 wherein the lug is positioned substantially at the pivotal connection.

5. The rotatory cutter of claim 1 wherein the lifting actuator is a hydraulic cylinder.

6. The rotary cutter of claim 1 wherein the lug following the channel path, causes the pivotal connection to follow a connection path.

7. The rotary cutter of claim 6 wherein the channel path and the connection path follow substantially the same path.

8. The rotary cutter of claim 1 wherein the lug is positioned at an end of the guide channel when the at least one wing section is pivoted upwards in the transport position.

9. The rotary cutter of claim 1 wherein the lug exits the guide channel through the opening while the wing section is still pivoting downwards towards the operating position.

10. The rotary cutter of claim 8 wherein the lug exits the guide channel when the at least one wing section has pivoted downwards to an approximately 65° angle to the center section.

11. The rotary cutter of claim 1 further comprising: an inner stop restricting the pivoting of the pivot member and the downward pivoting of the at least one wing section; and, an outer stop restricting the pivoting of the pivot member and the upward pivoting of the at least one wing section

12. The rotary cutter of claim 1 wherein the ground wheels are provided behind the center section and the at least one wing section.
